(19) United States
(12) Patent Application Publication
(10) Pub. No.: US 2002/0068888 A1
(43) Pub. Date: Jun. 6, 2002

(54) Back massage device

(76) Inventors: Rong-Shuang Wang, EHT, NJ (US); Chung-Shing Wang, Cherry Hill, NJ (US)

Correspondence Address: Rong-Shuang Wang, 609 Shires Way, EHT, NJ, 08234, US

(21) Appl. No.: 09/729,684

(22) Filed: Dec. 5, 2000

(51) Int. Cl. A61H 7/00

(52) U.S. Cl. 601/136; 601/134

(57) ABSTRACT

A back massage device having spaced mounts on one side of a base and a fastening means, e.g. adhesive tapes or the hook-strips of the VELCRO, on the other side. The device has no moving parts, is small, and can be used at home, in office, or in a car. The user just installs the device on a generally vertical surface, like a wall or a chair back, and rubs his/her back against the mounts while sitting or standing to achieve the massaging effects.

### FIELD OF INVENTION

The present invention is a manual back massage device.

### BACKGROUND OF THE INVENTION

Not everybody has a back problem per se, but almost everybody has a need to massage his/her back once for a while, just like he/she rubs his/her neck once for a while. It is easy to rub the neck, and quite often one does it unconsciously. But because it is not so easy to rub the back by one's own hands, quite often, one tends to endure the discomfort until the time when he/she decides to take a rest, clean up and finds a device or person to have a massage. Many back massage devices have been invented. Most of them have moving parts. Some need electricity. Some use rollers. Some use vibration. Some are for area massage, like a full-back massage. Some need the user to remove his/her coats. Some need the user to lie down. Some need to be set up. Some need hands for operation and/or control. In general, they are not simple, convenient, and effective enough.

### OBJECTIVE OF THE INVENTION

The primary objective of this invention is to provide a simple back massage device that one can rub his/her back against the device to get an effective back massage while standing or sitting.

Another objective of this invention is to provide a simple back massage device from which one can get an effect of massage much like the massage done by a human hand.

Another objective of this invention is to provide a simple back massage device that one can get a single point as well as multiple points massages.

Another objective of this invention is to provide a simple back massage device that can be easily pre-installed almost any generally vertical surface and one can use it without any preparation, e.g. removing clothing.

Another objective of this invention is to provide a simple back massage that, while massaging, one can have a gentle exercise of his/her body as a side benefit.

Yet another objective of this invention is to provide a simple back massage device, so simple, like a building block, that one can install more than one device at different positions relative to his/her height to suit his/her need.

### BRIEF DESCRIPTION OF THE DRAWINGS

FIG. 1 is the top view of a configuration of this invention.

FIG. 2 is the side view of the configuration shown in FIG. 1.

FIG. 3 is the bottom view of the configuration shown in FIG. 1.

FIG. 4 is the top view of another configuration of this invention.

FIG. 5 is the side view of the configuration shown in FIG. 4.

FIG. 6 is the bottom view of the configuration shown in FIG. 4.

### DETAILED DESCRIPTION OF THE INVENTION

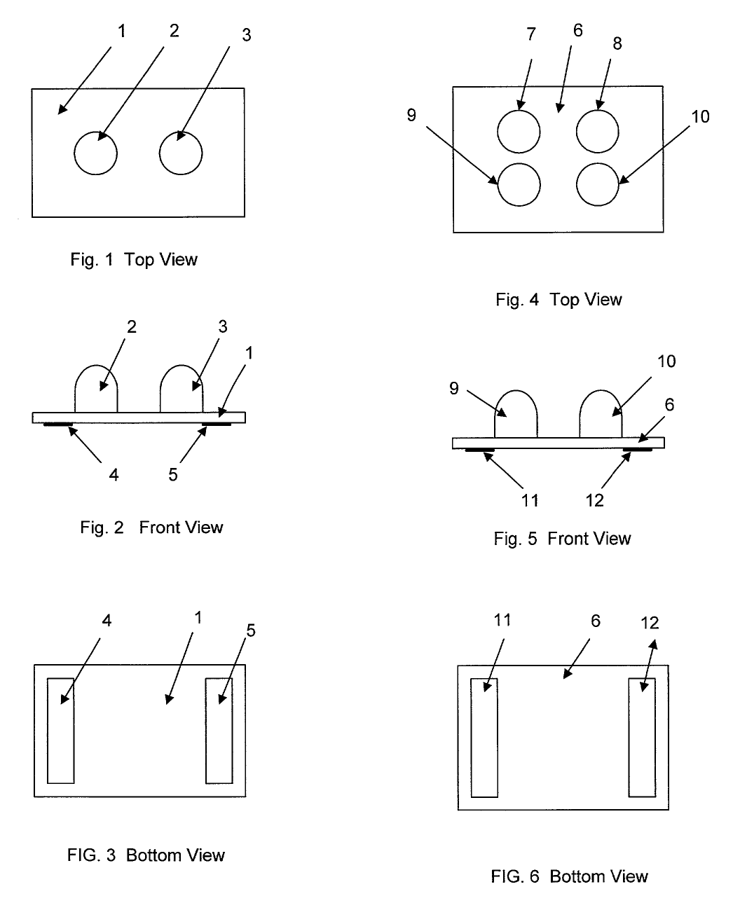

FIG. 1 is the top view of a configuration of this invention. This back massage device has a base [1]. On one side of the base [1], there is a set of two mounts [2,3]. The mounts [2,3] do not move or rotate during massaging. The distance between the peaks of the two mounts [2,3] is related to an adult's back, and is less than 9 inches and greater than 2 inches. Such a distance ensures that one can have a balanced two points massage if the two mounts [2,3] are used simultaneously, e.g. one mount on each side of the spine, and can easily use just one of the two mounts [2,3] to get a single point massage, like accupressure. The two mounts [2,3] may be permanently installed on the base [1], i.e., the distance between the two mounts [2,3] is fixed and cannot be changed. However, the distance can be made changeable when one of the mounts [2,3] is installed on the base by using a release/secure mechanism, like snap, screw or VELCRO. The base [1] is preferably made of a rigid material, like plastic.

FIG. 2 is the side view of the configuration shown in FIG. 1. The mounts [2,3] have an identical height of greater than one inch above the lowest surface of the base [1] to ensure that, during massaging, the mounts [2,3] are high enough to prevent one's back from touching the base [1] and/or the surface on which the base [1] is secured. The height is also less than four inches to ensure a better stability for the device of a small base during massaging. The mounts [2,3] or the top portions of them can be made of any semi-rigid or rigid materials. However, a semi-rigid material, like rubber, is preferred, because it can better deliver an effective and comfortable massage.

FIG. 3 is the bottom view of the configuration shown in FIG. 1. A fastening means [4,5], like adhesive tapes or hook-strips of the VELCRO, is installed on the bottom of the base [1]. The fastening means [4,5] is used for securing the massage device on a generally vertical surface, like a wall. Adhesive tapes are more suitable for permanent securing. With the VELCRO, one can easily adjust the installation position, or use the massage device anywhere having a generally vertical fabric surface, like a car seat back. Needless to say it is not necessary to use adhesive tape or VELCRO for securing the massage device. One can, for example, use nails to secure the massage device on a wall. FIG. 4 is the top view of another configuration of this invention. This back massage device has a base [6]. On one side of the base [6], there are four mounts [7,8,9,10]. The mounts [7,8,9,10] do not move or rotate during massaging. The mounts [7,8] are a set, and the mounts [9,10] are another set. The two sets are generally parallel to each other. The distance between the peaks of the mounts [7,8] or between the peaks of the mounts [9,10] is related to an adult's back, and is less than 9 inches and greater than 2 inches. The distance between the two sets, mounts [7,8] and mounts [9,10], is preferably close, say less than four inches. This arrangement of the four mounts [7,8,9,10] ensures that one can easily get a balanced multiple points massage by the four mounts [7,8,9,10] without much trying to adjust his/her back to the device. The base [6] is preferably made of a rigid material, like plastic.

FIG. 5 is the side view of the configuration shown in FIG. 4. The characteristics of the mounts [7,8,9,10] are the same as that of the mounts [2,3] described above.

FIG. 6 is the bottom view of the configuration shown in FIG. 4. The fasteners [11,12] are arranged in the same manner on the bottom of the base [6] as the fasteners [4,5] are arranged on the bottom of the base [1] as described above.

Although this invention has been described with a certain degree of particularity, it is to be understood that the present disclosure has been made by way of example only and that numerous changes in the detailed construction may be resorted to without departing from the spirit and scope of the invention as hereinafter claimed.

I claim:

1. A back massage device having a set of two non-moving/rotating mounts of equal height on one side of a base; the distance between the peaks of the two mounts being less than 9 inches and greater than two inches; the height being greater than one inch and less than four inches.

2. A back massage device having two sets of two non-moving/rotating mounts of equal height on one side of a base; the distance between the peaks of two mounts of either set being less than 9 inches and greater than two inches; the distance between the two sets being less than four inches; the height being greater than one inch and less than four inches.

3. A back massage device according to claim 1, whereas a fastening means is installed. on the bottom of the base.

4. A back massage device according to claim 2, whereas a fastening means is installed. on the bottom of the base.

5. A back massage device according to claim 3, whereas the fastening means is multiple hook-strips of the VELCRO.

6. A back massage device according to claim 4, whereas the fastening means is multiple hook-strips of the VELCRO.
